(19) United States
(12) Patent Application Publication
(10) Pub. No.: US 2012/0068548 A1
(43) Pub. Date: Mar. 22, 2012

(54) WIRELESS POWER SUPPLY APPARATUS

(75) Inventors: Yuki Endo, Tokyo (JP); Yasuo Furukawa, Tokyo (JP)

(73) Assignee: ADVANTEST CORPORATION, Tokyo (JP)

(21) Appl. No.: 13/222,821

(22) Filed: Aug. 31, 2011

Related U.S. Application Data
(60) Provisional application No. 61/383,479, filed on Sep. 16, 2010.

(51) Int. Cl. H02J 17/00

(52) U.S. Cl. 307/104

(57) ABSTRACT

A wireless power supply apparatus transmits an electric power signal including any one of an electric field, a magnetic field, and an electromagnetic field. A bridge circuit includes multiple switches. A control unit performs switching control of the multiple switches of the bridge circuit at a first frequency configured as a transmission frequency. A transmission coil and a resonance capacitor form a resonance antenna, which is connected to the bridge circuit. The resonance frequency of the resonance antenna thus formed is a second frequency that is equal to or higher than the first frequency. A control unit is configured to be capable of adjusting the length of the dead time during which the multiple switches are all turned off at the same time.

### BACKGROUND OF THE INVENTION

1. Field of the Invention

The present invention relates to a wireless power supply technique.

2. Description of the Related Art

In recent years, wireless (contactless) power transmission has been receiving attention as a power supply technique for electronic devices such as cellular phone terminals, laptop computers, etc., or for electric vehicles. Wireless power supply transmission can be classified into three principal methods using an electromagnetic induction, an electromagnetic wave reception, and an electric field/magnetic field resonance.

The electromagnetic induction method is employed to supply electric power at a short range (several cm or less), which enables electric power of several hundred watts to be transmitted in a band that is equal to or lower than several hundred kHz. The power use efficiency thereof is on the order of 60% to 98%. In a case in which electric power is to be supplied over a relatively long range of several meters or more, the electromagnetic wave reception method is employed. The electromagnetic wave reception method allows electric power of several watts or less to be transmitted in a band between medium waves and microwaves. However, the power use efficiency thereof is small. The electric field/magnetic field resonance method has been receiving attention as a method for supplying electric power with relatively high efficiency at a middle range on the order of several meters (see Non-patent document 1).

### RELATED ART DOCUMENTS

### Patent Documents

### [Non-Patent Document 1]

A. Karalis, J. D. Joannopoulos, M. Soljacic, “Efficient wireless non-radiative mid-range energy transfer” ANNALS of PHYSICS Vol. 323, January 2008, pp. 34-48.

The Q value is known as an important parameter in electric power transmission using the electric field (magnetic field) resonance method. FIG. 1A is a diagram which shows an example of a wireless power supply system. A wireless power supply system 1100 includes a wireless power supply apparatus 1200 and a wireless power receiving apparatus 1300. The wireless power supply apparatus 1200 includes a transmission coil L_{T1}, a resonance capacitor C_{T}, and an AC power supply 10. The AC power supply 10 is configured to generate an electric signal (driving signal) S2 having a transmission frequency f₁. The resonance capacitor C_{T} and the transmission coil L_{T1} form a resonance circuit. The resonance frequency of the resonance circuit thus formed is tuned to the frequency of the electric signal S2. The transmission coil L_{T1} is configured to transmit an electric power signal S1.

The wireless power receiving apparatus 1300 includes a reception coil L_{R1}, a resonance capacitor C_{R}, and a load circuit 20. The resonance capacitor C_{R}, reception coil L_{R1}, and the load circuit 20 form a resonance circuit. The resonance frequency of the resonance circuit thus formed is tuned to the frequency of the electric power signal S1.

In order to tune the wireless power supply apparatus 1200 and the wireless power receiving apparatus 1300 to the frequency of the electric signal S2, the resonance capacitors C_{T} and C_{R} are each configured as a variable capacitor as shown in FIG. 1B.

Such a variable capacitor has multiple capacitors C and multiple switches SW for switching these capacitors. With such a variable capacitor shown in FIG. 1B, as the number of capacitance steps becomes greater, the number of components such as capacitors, switches, etc., also becomes greater, leading to a problem of an increased circuit area and a problem of increased costs.

### SUMMARY OF THE INVENTION

The present invention has been made in order to solve such a problem. Accordingly, it is an exemplary purpose of the present invention to provide a wireless power supply system having an advantage of suppressing an increase in the number of circuit components.

An embodiment of the present invention relates to a wireless power supply apparatus configured to transmit an electric power signal including any one of an electric field, a magnetic field, and an electromagnetic field. The wireless power supply apparatus comprises: a bridge circuit comprising multiple switches; a control unit configured to perform, at a first frequency configured as a transmission frequency, switching control of the multiple switches included in the bridge circuit; and a resonance antenna connected to the bridge circuit, comprising a transmission coil configured to transmit an electric power signal and a resonance capacitor arranged in series with the transmission coil, and configured to have a second frequency as a resonance frequency that is equal to or higher than the first frequency. The control unit is configured to be capable of adjusting the length of a dead time during which the multiple switches are all turned off at the same time.

With such an embodiment, by optimizing the length of the dead time, such an arrangement provides a resonance state without changing the resonance frequency of the resonance antenna. That is to say, such an arrangement does not require a configuration for adjusting the resonance frequency of the resonance antenna. Thus, such an arrangement provides an advantage of a reduced number of circuit components.

Also, the control unit may be configured to set the length of the dead time such that partial resonance occurs between a coil current that flows through the transmission coil and the resonance antenna.

Also, the control unit may be configured to turn off the multiple switches at a timing at which the coil current that flows through the transmission coil becomes zero.

Also, the bridge circuit may comprise a half-bridge circuit. Also, the bridge circuit may comprise a full-bridge circuit.

Another embodiment of the present invention relates to a wireless power supply system. The wireless power supply system comprises: a wireless power supply apparatus according to any one of the aforementioned embodiments; and a wireless power receiving apparatus configured to receive an electric power signal transmitted from the wireless power supply apparatus.

It is to be noted that any arbitrary combination or rearrangement of the above-described structural components and so forth is effective as and encompassed by the present embodiments. Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A and 1B are diagrams showing an example of a wireless power supply system;

FIG. 2 is a circuit diagram which shows a configuration of a wireless power supply system according to an embodiment;

FIG. 3 is a waveform diagram which shows the operation of a wireless power supply apparatus shown in FIG. 2;

FIG. 4 is a circuit diagram which shows an example configuration of a bridge circuit;

FIG. 5 is a waveform diagram which shows the operation in a case in which the bridge circuit shown in FIG. 4 is employed;

FIG. 6 is a circuit diagram which shows a configuration of a wireless power supply apparatus according to a modification;

FIG. 7 is a waveform diagram which shows the operation of the wireless power supply apparatus shown in FIG. 6;

FIG. 8 is a circuit diagram which shows a configuration of a wireless power supply system according to a second embodiment;

FIGS. 9A and 9B are circuit diagrams showing the operation of a wireless power receiving apparatus shown in FIG. 8;

FIG. 10 is a waveform diagram which shows the operation of the wireless power receiving apparatus shown in FIG. 8;

FIG. 11 is a waveform diagram which shows the operation of a synchronization rectifier circuit according to a comparison technique;

FIG. 12 is a circuit diagram which shows a configuration of a wireless power receiving apparatus according to a first modification;

FIG. 13 is a circuit diagram which shows a configuration of a wireless power receiving apparatus according to a second modification;

FIG. 14 is an equivalent circuit diagram of the wireless power supply system shown in FIG. 8;

FIG. 15 is a time chart which shows the operation of a wireless power supply system according to a third modification; and

FIG. 16 is a circuit diagram which shows a configuration of a wireless power receiving apparatus according to a fourth modification.

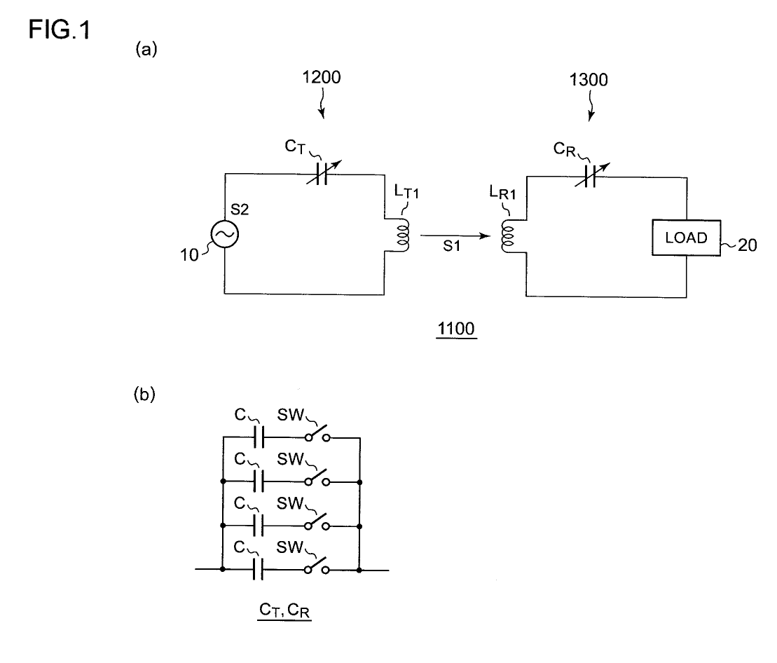

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not affect the electric connection therebetween, in addition to a state in which the member A is physically and directly connected to the member B.

Similarly, the state represented by the phrase “the member C is provided between the member A and the member B” includes a state in which the member A is indirectly connected to the member C, or the member B is indirectly connected to the member C via another member that does not affect the electric connection therebetween, in addition to a state in which the member A is directly connected to the member C, or the member B is directly connected to the member C.

### First Embodiment

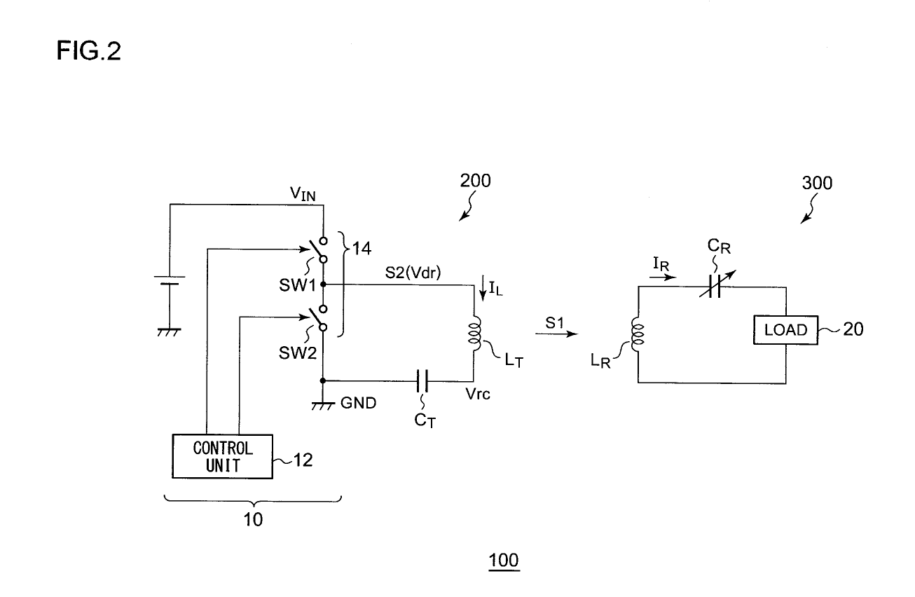

FIG. 2 is a circuit diagram which shows a configuration of a wireless power supply system 100 according to a first embodiment. The wireless power supply system 100 includes a wireless power supply apparatus 200 and a wireless power receiving apparatus 300.

First, description will be made regarding the configuration of the wireless power receiving apparatus 300. The wireless power receiving apparatus 300 receives an electric power signal S1 transmitted from the wireless power supply apparatus 200. The wireless power receiving apparatus 300 includes a reception coil L_{R}, a resonance capacitor C_{R}, and a load circuit 20. The resonance capacitor C_{R} is arranged such that it and the reception coil L_{R} form a resonance circuit. The resonance frequency of the resonance circuit is tuned to the electric power signal S1.

The reception coil L_{R} receives the electric power signal S1 from the wireless power supply apparatus 200. An induced current (resonance current) I_{R} that corresponds to the electric power signal S1 flows through the reception coil L_{R}. The wireless power receiving apparatus 300 retrieves electric power from the induced current. The load circuit 20 is a circuit configured to operate receiving the supply of electric power from the wireless power supply apparatus 200. The usage and the configuration of the load circuit 20 is not restricted in particular.

The wireless power supply apparatus 200 transmits an electric power signal S1 to the wireless power receiving apparatus 300. As such an electric power signal 51, the wireless power supply system 100 uses the near-field component (electric field, magnetic field, or electromagnetic field) of electromagnetic waves that has not become radio waves.

The wireless power supply apparatus 200 includes an AC power supply 10, a transmission coil L_{T}, and a resonance capacitor C_{T}. The AC power supply 10 generates an electric signal S2 having a predetermined frequency, or subjected to frequency-modulation, phase-modulation, amplitude-modulation, or the like. For simplicity of description and ease of understanding, description will be made in the present embodiment regarding an arrangement in which the electric signal S2 is an AC signal having a constant frequency.

The AC power supply 10 includes a bridge circuit 14 and its control unit 12. The bridge circuit 14 shown in FIG. 2 is configured as a half-bridge circuit including a high-side switch SW1 and a low-side switch SW2.

The control unit 12 of the AC power supply 10 controls the on/off states of the high-side switch SW1 and the low-side switch SW2. When the transmission frequency of the electric power signal S1 is set to a first frequency f₁, the switching frequency of the high-side switch SW1 and the low-side switch SW2, i.e., the frequency of the electric signal S2, is set to the same value as that of the first frequency f₁.

The resonance capacitor C_{T} and the transmission coil L_{T} form a resonance antenna. The transmission coil L_{T} is configured to emit, into the air, the electric signal S2 generated by the AC power supply 10 in the form of a near-field signal (electric power signal) S1 including any one of an electric field, magnetic field, or electromagnetic field. The resonance capacitor C_{T} is arranged in series with the transmission coil L_{T}, and is arranged such that it and the low-side switch SW2 form a closed loop.

With typical wireless power supply apparatuses, the resonance frequency of a resonance antenna formed of the resonance capacitor C_{T} and the transmission coil L_{T1} is tuned to the first frequency f₁ of the electric signal S2. In contrast, with the wireless power supply system 100 according to the embodiment, the resonance frequency of the resonance antenna of the wireless power supply apparatus 200 is set to a second frequency f₂ that is equal to or higher than the first frequency f₁. In a case in which the electric power signal S1 is subjected to frequency modulation or phase modulation, or in a case in which the transmission frequency f₁ is switchable between multiple values, the resonance frequency f₂ of the resonance antenna is set to a frequency that is equal to or higher than the highest of the possible frequencies of the transmission frequency f₁.

With the wireless power supply apparatus 200 according to the embodiment, instead of tuning the resonance frequency f₂ of the resonance antenna to the first frequency f₁ of the electric signal S2, the control unit 12 adjusts the length of a dead time in which the multiple switches SW1 and SW2 of the bridge circuit 14 are all turned off at the same time.

Specifically, the control unit 12 sets the length of the dead time such that partial resonance occurs between the coil current I_{L} that flows through the transmission coil L_{T} and the resonance antenna formed of L_{T} and C_{T}. The control unit 12 turns off the multiple switches SW1 and SW2 at a timing at which the coil current I_{L} that flows through the transmission coil L_{T} becomes zero.

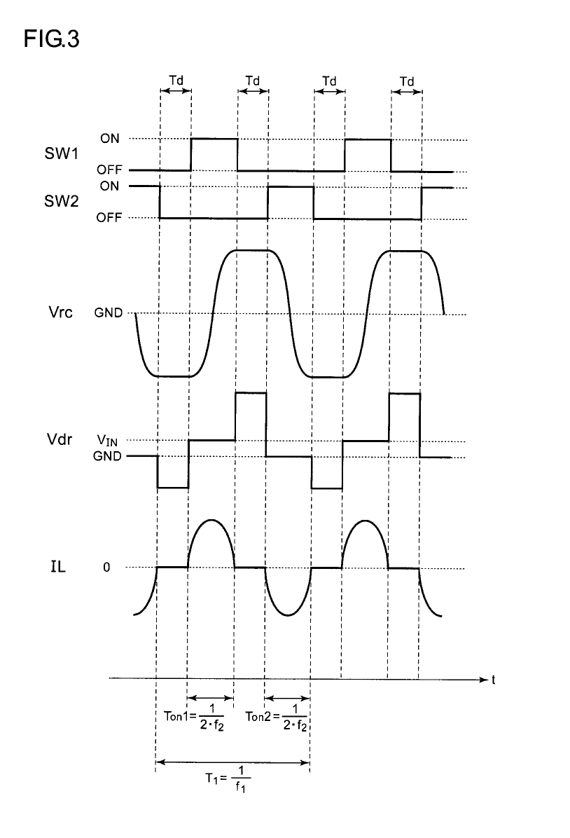

FIG. 3 is a waveform diagram which shows the operation of the wireless power supply apparatus 200 shown in FIG. 2. The vertical axis and the horizontal axis shown in the waveform diagrams and the time charts in the present specification are expanded or reduced as appropriate for ease of understanding. Also, each waveform shown in the drawings is simplified for ease of understanding.

From top to bottom in the following order, FIG. 3 shows waveform diagrams showing the on/off states of the high-side switch SW1 and the low-side switch SW2, the voltage Vrc between both terminals of the resonance capacitor C_{T}, the voltage Vdr of the electric signal (driving signal) S2, and the coil current I_{L}.

The high-side switch SW1 and the low-side switch SW2 are subjected to a switching operation at the first frequency f₁. That is to say, the switching periods of the high-side switch SW1 and the low-side switch SW2 are each represented by T₁=1/f₁. The dead time Td is provided between the on period Ton1 of the high-side transistor SW1 and the on period Ton2 of the low-side transistor SW2. The length of the dead time Td is set such that the relation Ton1=Ton2=1/(2×f₂) holds true.

In the on period Ton1, the driving voltage Vdr=V_{IN} is applied to the resonance antenna formed of L_{T} and C_{T}. In this period, the coil current I_{L} has a half-wave waveform that corresponds to the resonance frequency f₂ of the resonance antenna formed of L_{T} and C_{T}. The resonance capacitor C_{T} is charged by the coil current I_{L}, which increases the voltage Vrc over time. When the coil current I_{L} becomes zero, the period transits to the dead time Td. During the dead time Td, the coil current I_{L} does not flow, and accordingly, the voltage Vcr is maintained at a constant level. Furthermore, the output terminal of the bridge circuit 14 is set to the high-impedance state, and accordingly, the driving voltage Vdr becomes indefinite.

After the dead time Td ends, the period transits to the on period Ton2, and the driving voltage Vdr becomes zero (GND, i.e., the ground potential). Thus, the resonance capacitor C_{T} is discharged, and the coil current I_{L} has a half-wave waveform. When the coil current I_{L} becomes zero, the period transits to the dead time Td again. The wireless power supply apparatus 200 repeatedly performs the aforementioned operation.

As described above, the wireless power supply apparatus 200 is capable of controlling the coil current I_{L} that flows in the on periods Ton1 and Ton2 such that partial resonance occurs between it and the resonance frequency f₂ of the resonance antenna formed of L_{T} and C_{T}, by adjusting the length of the dead time Td according to the transmission frequency f₁ while maintaining the resonance frequency f₂ of the resonance antenna formed of L_{T} and C_{T} at a constant level.

Such a wireless power supply apparatus 200 does not require a variable capacitor or a variable inductor in order to change the resonance frequency. Thus, such an arrangement provides an advantage of a reduced number of circuit components, and an advantage of a reduced circuit area.

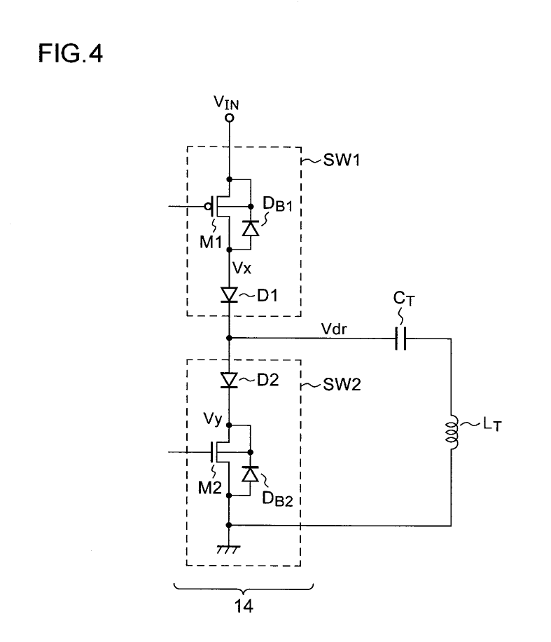

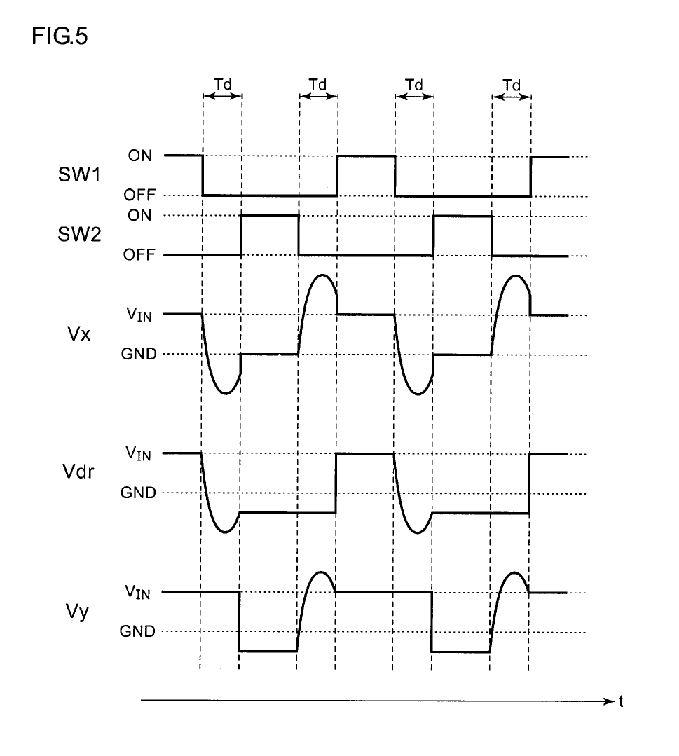

FIG. 4 is a circuit diagram which shows an example configuration of the bridge circuit 14. The high-side switch SW1 and the low-side switch SW2 are respectively configured as FETs (Field Effect Transistors) M1 and M2. Between the back gate and the drain of the transistors M1 and M2, there are respective body diodes D_{B1} and D_{B2}. In order to prevent a current from flowing through the body diode D_{B1} in the off state of the transistor M1, a diode D1 is arranged in a direction that is the reverse of that of the body diode D_{B1}. For the same reason, a diode D2 is arranged in series with the transistor M2 in a direction that is the reverse of that of the body diode D_{B2}. It should be noted that an N-channel MOSFET may be employed as the high-side switch SW1.

FIG. 5 is a waveform diagram showing the operation in a case of employing the bridge circuit 14 shown in FIG. 4. Such an arrangement employing the bridge circuit 14 shown in FIG. 4 provides an operating waveform that differs from the operating waveform shown in FIG. 3 provided by the wireless power supply apparatus 200 shown in FIG. 2. However, by adjusting the dead time Td, such an arrangement provides the same advantages as those of the wireless power supply apparatus 200 shown in FIG. 2.

It should be noted that an FET having an electric conductivity that is the reverse of that of the transistor M1 may be employed, instead of employing such a diode D1. In the same way, an FET having an electric conductivity that is the reverse of that of the transistor M2 may be employed, instead of employing such a diode D2. Alternatively, such diodes D1 and D2 may be omitted.

Description has been made regarding the present invention with reference to the embodiments. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

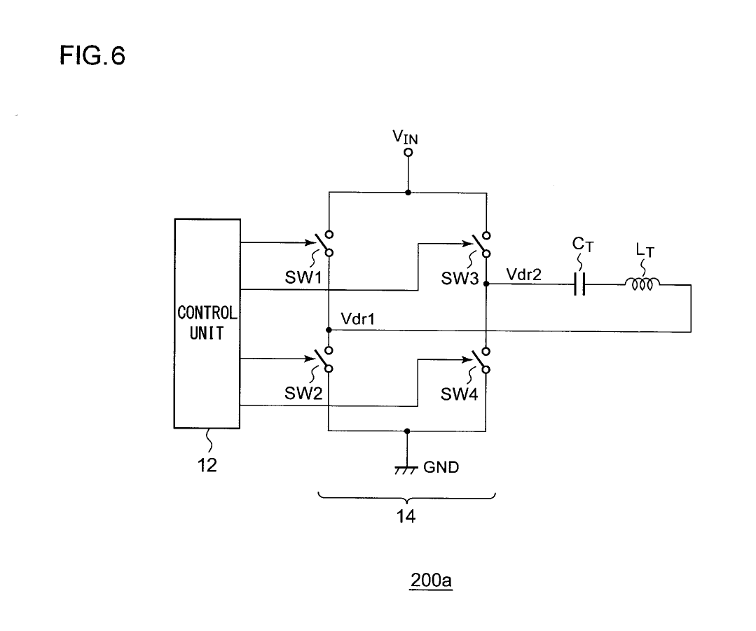

Description has been made in the embodiment regarding an arrangement in which a half-bridge circuit is employed as the bridge circuit 14. Also, a full-bridge circuit (H-bridge circuit) may be employed instead of such a half-bridge circuit. FIG. 6 is a circuit diagram which shows a configuration of a wireless power supply apparatus 200a according to a modification. Such a full-bridge circuit includes switches SW1 through SW4. In the on period Ton1 of the switch SW1, a control unit 12 turns on the switch SW4. Furthermore, in the on period Ton2 of the switch SW2, the control unit 12 turns on the switch SW3. Dead time Td is set between the on periods Ton1 and Ton2. The length of the dead time Td is adjusted.

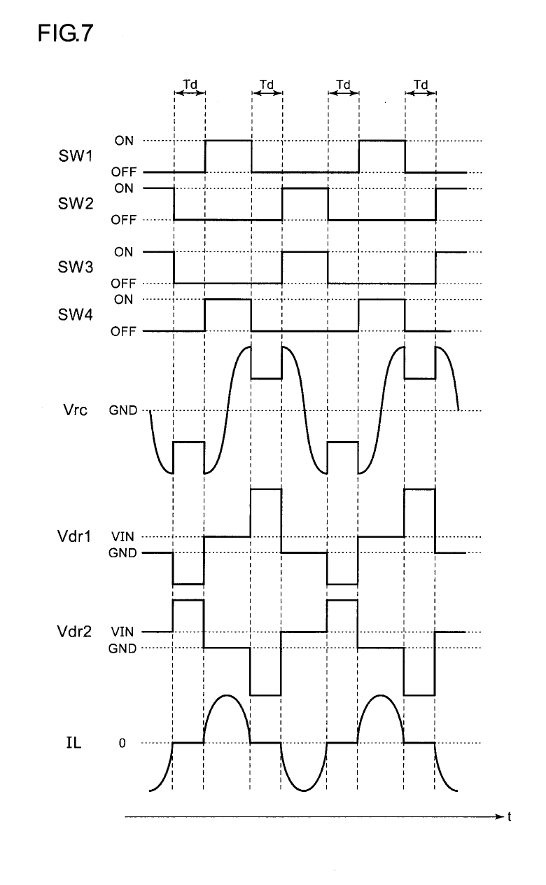

FIG. 7 is a waveform diagram showing the operation of the wireless power supply apparatus 200a shown in FIG. 6. Such an arrangement employing such an H-bridge circuit is capable of controlling the coil current I_{L} such that partial resonance occurs between it and the resonance frequency, in the same way as the aforementioned arrangement employing a half-bridge circuit. Thus, such an arrangement provides the same advantages as those of the circuit shown in FIG. 2.

With such wireless power transmission using a resonance method, if the strength of the coupling between the power supply (power transmission) side and the power reception (power receiving) side is excessively high, in some cases, such an arrangement leads to deterioration in the power transmission efficiency. With the aforementioned frequency adjustment technique using the dead time Td, such an arrangement is capable of intentionally reducing the resonance level so as to reduce the coupling strength, without changing the transmission frequency. Thus, by reducing the coupling strength, such an arrangement also provides an advantage of preventing such deterioration in the power transmission efficiency.

### Second Embodiment

Description has been made in the first embodiment regarding the power supply apparatus. Description will be made in the second embodiment regarding a system formed by combining a power receiving apparatus with a power supply apparatus according to the first embodiment, or regarding a power receiving apparatus which can be used as a stand-alone apparatus.

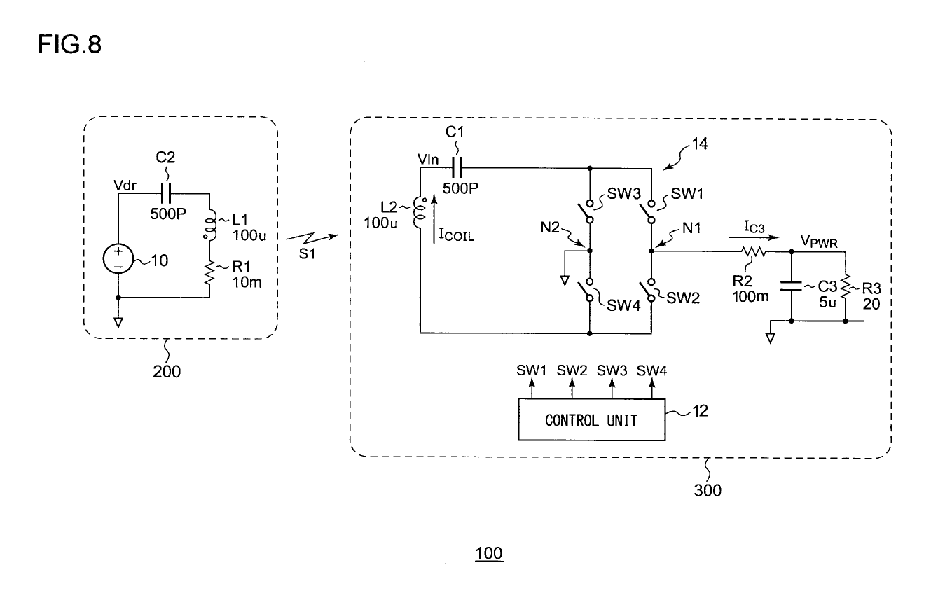

FIG. 8 is a circuit diagram which shows a configuration of a wireless power supply system 100 according to a second embodiment. In this circuit diagram, circuit constants are shown for exemplary purposes. However, such circuit constants are not intended to limit the present invention. The wireless power supply system 100 includes a wireless power supply apparatus 200 and a wireless power receiving apparatus 300. First, description will be made regarding the configuration of the wireless power supply apparatus 200.

The wireless power supply apparatus 200 transmits an electric power signal to the wireless power receiving apparatus 300. As an electric power signal S1, the wireless power supply system 100 uses the near-field component (electric field, magnetic field, or electromagnetic field) of electromagnetic waves that has not become radio waves.

The wireless power supply apparatus 200 includes an AC power supply 10, a transmission coil L1, and a capacitor C2. The AC power supply 10 generates an electric signal S2 having a predetermined frequency, or subjected to frequency-modulation, phase-modulation, amplitude-modulation, or the like. For simplicity of description and ease of understanding, description will be made in the present embodiment regarding an arrangement in which the electric signal S2 is an AC signal having a constant frequency. For example, the frequency of the electric signal S2 is selected from a range between several hundred KHz and several MHz.

The transmission coil L1 is an antenna configured to emit the electric signal S2 generated by the AC power supply 10, as a near-field signal (electric power signal) including any one of an electric field, magnetic field, or electromagnetic field. The transmission capacitor C2 is arranged in series with the transmission coil L1. The resistor R1 represents the resistance component that is in series with the transmission coil L1.

The above is the configuration of the wireless power supply apparatus 200. Next, description will be made regarding the configuration of the wireless power receiving apparatus 300.

The wireless power receiving apparatus 300 receives the electric power signal S1 transmitted from the wireless power supply apparatus 200.

The reception coil L2 receives the electric power signal S1 from the transmission coil L1. An induced current (resonant current) I_{COIL} that corresponds to the electric power signal S1 flows through the reception coil L2. The wireless power receiving apparatus 300 acquires electric power via the induced current thus generated.

The wireless power receiving apparatus 300 includes a reception coil L2, a resonance capacitor C1, an H-bridge circuit 14, a control unit 12 and a power storage capacitor C3. Together with the reception coil L2, the resonance capacitor C1 forms a resonance circuit.

A first terminal of the power storage capacitor C3 is grounded, and the electric potential thereof is fixed. The H-bridge circuit 14 includes a first switch SW1 through a fourth switch SW4. The first switch SW1 and the second switch SW2 are sequentially connected in series so as to form a closed loop including the reception coil L2 and the resonance capacitor C1. A connection node N1 that connects the first switch SW1 and the second switch SW2 is connected to a second terminal of the power storage capacitor C3. A loss resistance R2 represents power loss that occurs in the wireless power receiving apparatus 300. A load resistor R3 represents a load driven by the electric power stored in the power storage capacitor C3, and does not represents a resistor arranged as a circuit component. A voltage V_{PWR} that develops at the power storage capacitor C3 is supplied to the load resistance R3.

The third switch SW3 and the fourth switch SW4 are sequentially arranged in series so as to form a path that is parallel to a path that includes the first switch SW1 and the second switch SW2. A connection node N2 that connects the third switch SW3 and the fourth switch SW4 is grounded, and has a fixed electric potential. The load resistor R3 may be controlled such that the voltage V_{PWR} that develops at the power storage capacitor C3 becomes the optimum value for increasing the Q value.

The first switch SW1 through the fourth switch SW4 are each configured as a semiconductor element such as a MOSFET (Metal Oxide Semiconductor Field Effect Transistor), a bipolar transistor, or an IGBT (Insulated Gate Bipolar Transistor), or the like.

A control unit 12 controls the first switch SW1 through the fourth switch SW4.

Specifically, the control unit 12 is configured to be capable of switching the state between a first state φ1 and a second state φ2. In the first state φ1, the first switch SW1 and the fourth switch SW4 are on, and the second switch SW2 and the third switch SW3 are off. In the second state φ2, the first switch SW1 and the fourth switch SW4 are off, and the second switch SW2 and the third switch SW3 are on.

The induced current I_{COIL} that develops at the reception coil L2 has an AC waveform. The control unit 12 adjusts a switching timing (phase) at which the state is switched between the first state φ1 and the second state φ2, such that the amplitude of the induced current I_{COIL} approaches the maximum value.

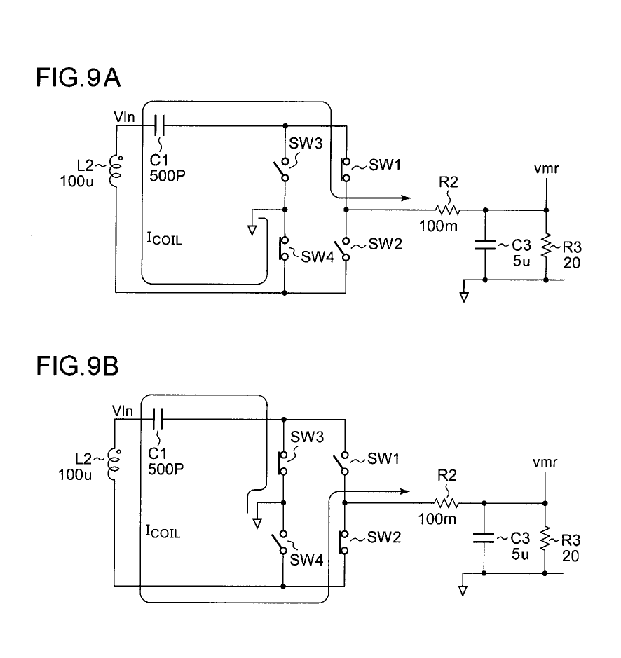

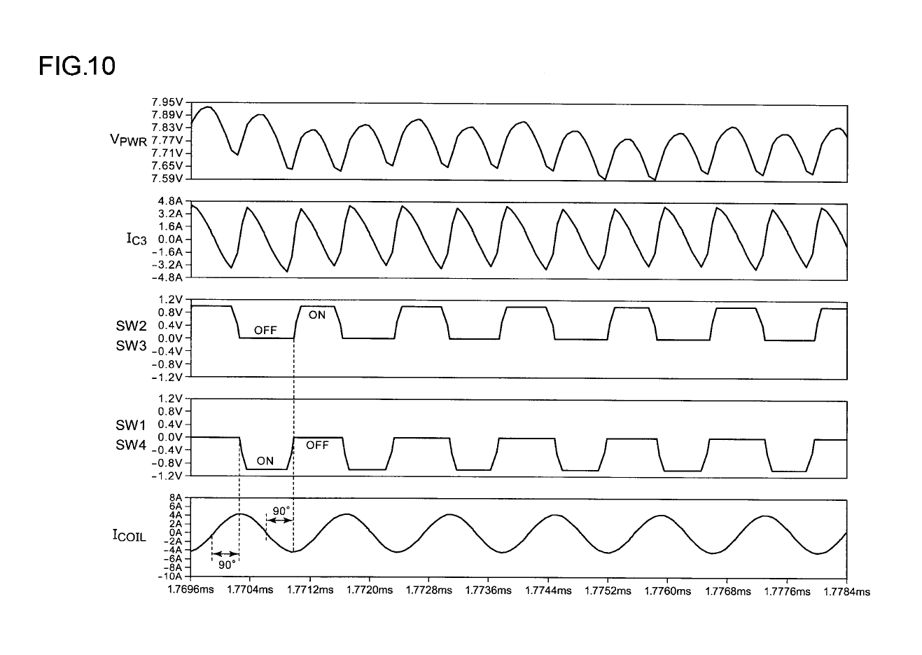

The above is the configuration of the wireless power supply system 100. Next, description will be made regarding the operation thereof. FIGS. 9A and 9B are circuit diagrams each showing the operation of the wireless power receiving apparatus 300 shown in FIG. 8. FIG. 9A shows the state of each switch and the current in the first state φ1, and FIG. 9B shows the state of each switch and the current in the second state φ2. FIG. 10 is a waveform diagram which shows the operation of the wireless power receiving apparatus 300 shown in FIG. 8. From the top and in the following order, FIG. 10 shows the voltage V_{PWR} that develops at the power storage capacitor C3, a current I_{C3} that flows into the power storage capacitor C3, the states of the second switch SW2 and the third switch SW3, the states of the first switch SW1 and the fourth switch SW4, and the induced current I_{COIL} that develops at the reception coil L2.

In FIG. 10, the states of the second switch SW2 and the third switch SW3 each correspond to the fully-on state when the voltage is +1 V, and correspond to the off state when the voltage is 0 V. On the other hand, the states of the first switch SW1 and the fourth switch SW4 each correspond to the fully-on state when the voltage is −1 V, and correspond to the off state when the voltage is 0 V. The voltage level which indicates the state of each switch is determined for convenience. The waveform is shown with the direction of the arrow shown in FIG. 8 as the positive direction.

First, the AC electric power signal S1 is transmitted from the wireless power supply apparatus 200 shown in FIG. 8. The induced current I_{COIL}, which is an AC current, flows through the reception coil L2 according to the electric power signal S1.

The control unit 12 controls the on/off state of each of the first switch SW1 through the fourth switch SW4 in synchronization with the electric power signal S1. In the first state φ1, the current I_{C3} flows from the ground terminal via the fourth switch SW4, the reception coil L2, the resonance capacitor C1, and the first switch SW1, as shown in FIG. 9A. In the second state φ2, the current I_{C3} flows from the ground terminal via the third switch SW3, the reception coil L2, the resonance capacitor C1, and the second switch SW2, as shown in FIG. 9B. The control unit 12 may monitor the induced current I_{COIL} or the electric power supplied to the load resistor R3, and may optimize the switching timing (phase) at which the H-bridge circuit 14 is switched such that the amplitude thereof approaches the maximum value.

In a case in which the power storage capacitor C3 has a sufficient capacitance to function as a voltage source, such a power storage capacitor C3 can be used as a driving voltage source for the resonance circuit. Thus, by means of the H-bridge circuit 14 and the control unit 12, by coupling the power storage capacitor C3 with the reception coil L2 at a phase shifted by 90 degrees with respect to the zero-crossing point of the induced current (resonance current) I_{COIL}, such an arrangement is capable of compensating for the loss due to the resistance component of the reception coil L2 and so forth by means of the power storage capacitor C3 functioning as a power supply.

The Q value of the resonance circuit is inversely proportional to the resistance R. However, if the power storage capacitor C3 can perfectly compensate for the power loss due to the resistance R, the resistance R can be regarded as zero, thereby providing a circuit equivalent to a resonance circuit having an infinite Q value.

As described above, with the wireless power receiving apparatus 300 according to the embodiment, by optimizing the switching timing (phase) at which the state of the H-bridge circuit 14 is switched between the first state φ1 and the second state φ2, such an arrangement is capable of applying the voltage that develops at the power storage capacitor C3 to the reception coil L2 at a suitable timing, thereby immensely improving the effective Q value.

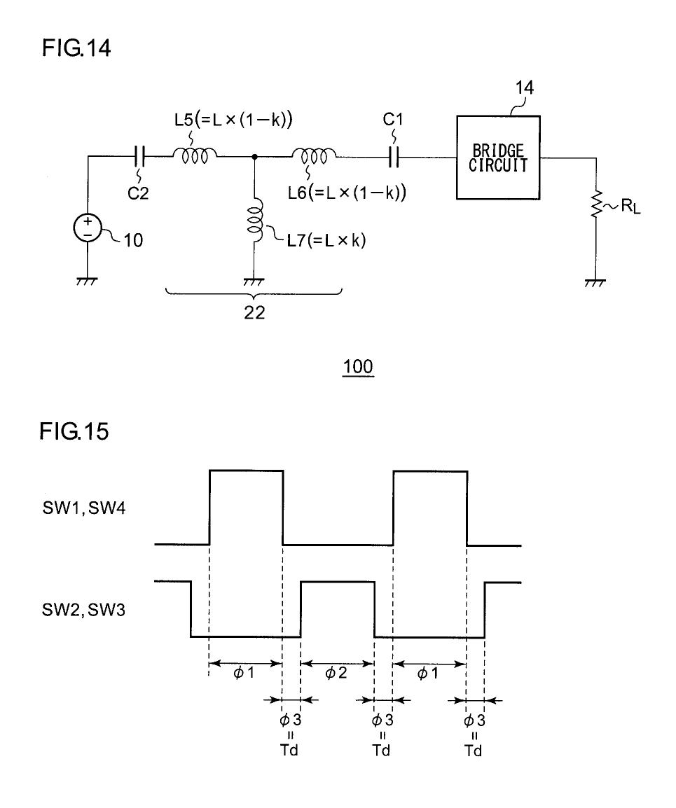

FIG. 14 is an equivalent circuit diagram showing the wireless power supply system 100 shown in FIG. 8. In the wireless power supply system 100 shown in FIG. 8, the transmission coil L1 and the reception coil L2, which are coupled with a coupling coefficient k, can be regarded as a T-shaped circuit 22 including inductors L5 through L7. When L1=L2=L, the inductances of the inductors L5 and L6 are each represented by L×(1−k), and the inductance of L7 is represented by L×k.

Optimization of the switching timing at which the H-bridge circuit 14 is switched between the first state φ1 and the second state φ2 is equivalent to optimization of impedance matching between the AC power supply 10 and the load resistor R3. That is to say, the H-bridge circuit 14 can be regarded as a switch-mode impedance matching circuit. If the output impedance of the AC power supply 10 or the coupling coefficient k changes, the impedance matching conditions also change. The phase of the switching operation of the H-bridge circuit 14 is controlled so as to provide optimum impedance matching.

With conventional arrangements, the resonance capacitor C1 or C2 is configured as a variable capacitor, and this variable capacitor is mechanically controlled by means of a motor so as to provide such impedance matching. In contrast, with the present embodiment, by controlling the switching state of the H-bridge circuit 14, such an arrangement provides the impedance matching electrically instead of mechanically.

With impedance matching by mechanical means, a high-speed control operation cannot be performed. This leads to a problem in that, in a case in which the wireless power receiving apparatus 300 moves, such an arrangement cannot maintain the impedance matching, leading to deterioration in the power supply efficiency. In contrast, the present embodiment provides high-speed impedance matching as compared to such a conventional arrangement. The present arrangement provides a highly efficient power supply even if the wireless power receiving apparatus 300 moves, or even if the power supply state of the wireless power supply apparatus 200 is switched at a high speed.

The wireless power receiving apparatus 300 having a high Q value provides high-efficiency electric power transmission even if the coupling coefficient k between the transmission coil L1 and the reception coil L2 is low, i.e., even if there is a great distance between the wireless power receiving apparatus 300 and the wireless power supply apparatus 200.

It should be noted that the switching timing of each of the first switch SW1 through the fourth switch SW4 is not restricted to such an arrangement described with reference to FIG. 10. By controlling the on/off switching timing, such an arrangement is capable of controlling the Q value of the resonance circuit. In a case of intentionally providing a low Q value, such an arrangement may intentionally shift the on/off switching timing from that shown in FIG. 10.

Furthermore, with such a configuration shown in FIG. 8, the H-bridge circuit 14 configured to raise the Q value also functions as a rectifier circuit. Thus, such an arrangement has another advantage in that there is no need to provide a rectifier circuit including a diode or the like as an additional circuit, unlike a modification described later.

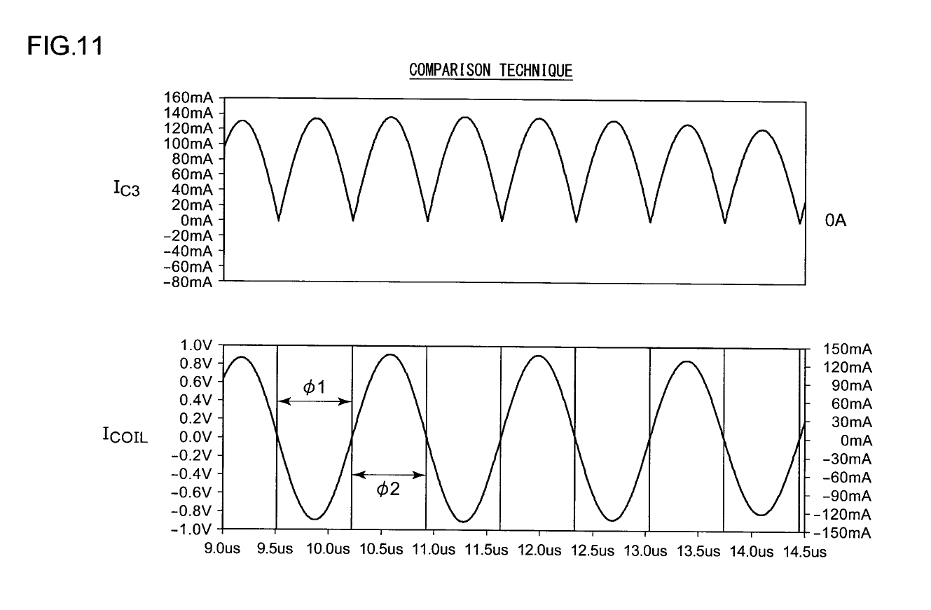

It should be noted that the aforementioned H-bridge circuit 14 must not be identified as a typical synchronous rectifier circuit. FIG. 11 is a waveform diagram which shows the operation of a synchronous rectifier circuit as a comparison technique. With such a synchronous rectifier circuit, the state is switched between the first state φ1 and the second state φ2 when a zero-crossing point occurs in the resonance current I_{COIL}. In this case, the current I_{C3} that flows into the power storage capacitor C3 has a waveform that has been subjected to full-wave rectification. It should be noted that, unlike rectification by means of a diode, voltage loss does not occur in this rectification. Such a synchronous rectifier circuit cannot compensate for the loss that occurs in the resonance circuit. Accordingly, such an arrangement does not provide an improved Q value.

Description has been made regarding the present invention with reference to the embodiments. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

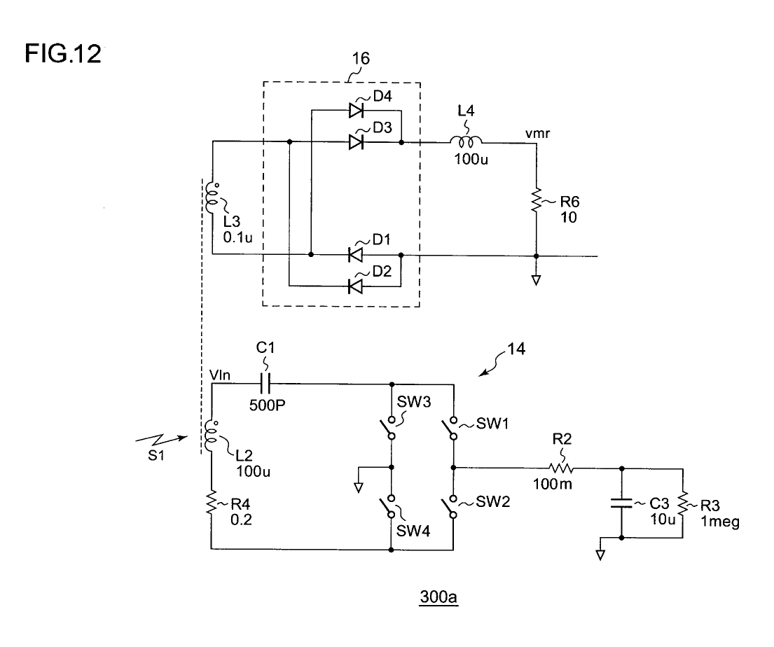

FIG. 12 is a circuit diagram which shows a configuration of a wireless power receiving apparatus 300a according to a first modification. It should be noted that a part of the circuit components that overlaps those shown in FIG. 8 are not shown. The point of difference between the wireless power receiving apparatus 300a shown in FIG. 12 and the wireless power receiving apparatus 300 shown in FIG. 8 is the position of the load. Specifically, in FIG. 12, the resistor R6 functions as a load, instead of the resistor R3. The resistor R3 arranged in parallel with the power storage capacitor C3 has a negligible effect.

The wireless power receiving apparatus 300a shown in FIG. 12 includes an auxiliary coil L3, a rectifier circuit 16, and an inductor L4, in addition to the wireless power receiving apparatus 300 shown in FIG. 8.

The auxiliary coil L3 is densely coupled with the reception coil L2. The rectifier circuit 16 performs full-wave rectification of a current I_{L3} that flows through the auxiliary coil L3. The inductor L4 is arranged on the output side of the rectifier circuit 16 in series with the load resistor R6.

With such a configuration shown in FIG. 12, the Q value of the resonance circuit comprising the reception coil L2 and the resonance capacitor C1 is raised by the Q value amplifier circuit including the H-bridge circuit 14 and the power storage capacitor C3. As a result, a large amount of current I_{L3} is induced in the auxiliary coil L3 densely coupled with the reception coil L2, thereby providing a large amount of electric power to the load resistor R6.

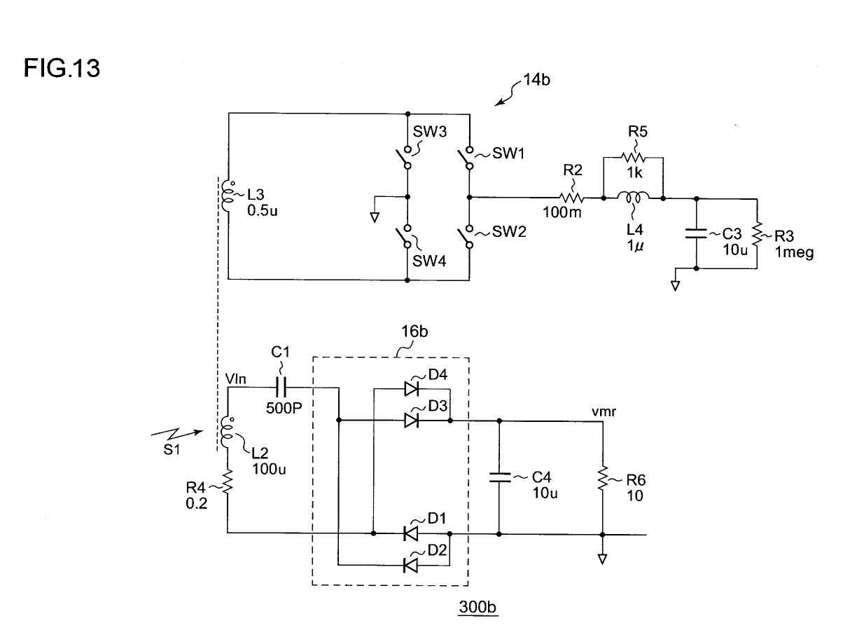

FIG. 13 is a circuit diagram which shows a configuration of a wireless power receiving apparatus 300b according to a second modification. The wireless power receiving apparatus 300b includes an auxiliary coil L3 densely coupled with the reception coil L2. With such an arrangement, an H-bridge circuit 14b is connected to the auxiliary coil L3, instead of the reception coil L2. An inductor L4 and a resistor R5 connected in parallel are arranged between the H-bridge circuit 14b and the power storage capacitor C3.

The rectifier circuit 16b performs full-wave rectification of the current that flows through the resonance circuit including the reception coil L2 and the resonance capacitor C1. The power storage capacitor C4 is arranged on the output side of the rectifier circuit 16b, and is configured to smooth the current thus subjected to full-wave rectification by the rectifier circuit 16b. The voltage that develops at the power storage capacitor C4 is supplied to the load resistor R6.

With such a configuration shown in FIG. 13, via the auxiliary coil L3, a Q value amplifier circuit comprising the H-bridge circuit 14b and the power storage capacitor C3 is capable of raising the Q value of the resonance circuit that includes the reception coil L2 and the resonance capacitor C1. As a result, such an arrangement is capable of receiving electric power with high efficiency.

Description has been made in the embodiment regarding an arrangement in which the H-bridge circuit 14 can be switched between the first state φ1 and the second state φ2, and in which the phase of switching these states is controlled. In the third modification, the following control operation is performed, instead of or in addition to the phase control.

In the third modification, the control unit 12 is capable of switching the state to a third state φ3 in which all of the first switch SW1 through the fourth switch SW4 are turned off, in addition to the first state φ1 and the second state φ2. The control unit 12 provides the third state φ3 as an intermediate state in at least one of the transitions from the first state φ1 to the second state φ2 or from the second state φ2 to the first state φ1, so as to adjust the length of the period of time for the third state φ2 (which will also be referred to as the “dead time Td”) such that the amplitude of the induced current I_{COIL} that flows through the reception coil L2 approaches the maximum value. FIG. 15 is a time chart which shows the operation of the wireless power supply system 100 according to a third modification.

The resonance frequency of the resonance circuit that comprises the reception coil L2, the resonance capacitor C1, and the H-bridge circuit 14, does not necessarily match the frequency of the electric power signal S1 generated by the wireless power supply apparatus 200. In this case, by adjusting the length of the dead time Td, such an arrangement allows the induced current I_{COIL} that flows in the first state φ1 and in the second state φ2 to partially resonate with the resonance circuit included in the wireless power receiving apparatus 300. That is to say, such an arrangement is capable of tuning the resonance frequency of the wireless power supply apparatus 200 to the frequency of the electric power signal S1, thereby improving the power supply efficiency.

Description has been made in the embodiment regarding an arrangement in which the H-bridge circuit 14 is employed as a switch-mode impedance matching circuit. Also, a half-bridge circuit may be employed.

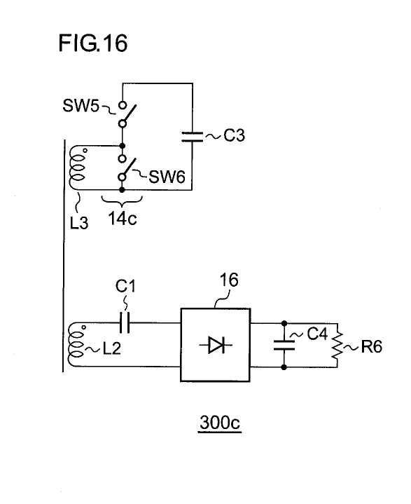

FIG. 16 is a circuit diagram which shows a configuration of a wireless power receiving apparatus 300c according to a fourth modification. The wireless power receiving apparatus 300c shown in FIG. 16 has a configuration obtained by replacing the H-bridge circuit 14b included in the wireless power receiving apparatus 300b shown in FIG. 13 with a half-bridge circuit 14c. The half-bridge circuit 14c includes a fifth switch SW5 and a sixth switch SW6. The fifth switch SW5 is connected to the power storage capacitor C3 and the auxiliary coil L3 so as to form a closed loop. The sixth switch SW6 is arranged between both terminals of the auxiliary coil L3.

With the fourth modification, by controlling the phase of switching on and off the fifth switch SW5 and the sixth switch SW6, such an arrangement is capable of providing impedance matching. Furthermore, by adjusting the length of the dead time during which the fifth switch SW5 and the sixth switch SW6 are off at the same time, such an arrangement is capable of using the partial resonance to improve the transmission efficiency.

While the preferred embodiments of the present invention have been described using specific terms, such description is for illustrative purposes only, and it is to be understood that changes and variations may be made without departing from the spirit or scope of the appended claims.

What is claimed is:

1. A wireless power supply apparatus configured to transmit an electric power signal including any one of an electric field, a magnetic field, and an electromagnetic field, the wireless power supply apparatus comprising:
a bridge circuit comprising a plurality of switches;
a control unit configured to perform, at a first frequency configured as a transmission frequency, switching control of the plurality of switches included in the bridge circuit; and
a resonance antenna connected to the bridge circuit, comprising a transmission coil configured to transmit an electric power signal and a resonance capacitor arranged in series with the transmission coil, and configured to have a second frequency as a resonance frequency that is equal to or higher than the first frequency,
wherein the control unit is configured to be capable of adjusting the length of a dead time during which the plurality of switches are all turned off at the same time.

2. A wireless power supply apparatus according to claim 1, wherein the control unit is configured to set the length of the dead time such that partial resonance occurs between a coil current that flows through the transmission coil and the resonance antenna.

3. A wireless power supply apparatus according to claim 1, wherein the control unit is configured to turn off the plurality of switches at a timing at which the coil current that flows through the transmission coil becomes zero.

4. A wireless power supply apparatus according to claim 1, wherein the bridge circuit comprises a half-bridge circuit.

5. A wireless power supply apparatus according to claim 1, wherein the bridge circuit comprises a full-bridge circuit.

6. A wireless power supply system comprising:
a wireless power supply apparatus configured to transmit an electric power signal including any one of an electric field, a magnetic field, and an electromagnetic field; and
a wireless power receiving apparatus configured to receive the electric power signal transmitted from the wireless power supply apparatus, wherein
the wireless power supply apparatus comprises:
a bridge circuit comprising a plurality of switches;
a control unit configured to perform, at a first frequency configured as a transmission frequency, switching control of the plurality of switches included in the bridge circuit; and
a resonance antenna connected to the bridge circuit, comprising a transmission coil configured to transmit an electric power signal and a resonance capacitor arranged in series with the transmission coil, and configured to have a second frequency as a resonance frequency that is equal to or higher than the first frequency,
wherein the control unit is configured to be capable of adjusting the length of a dead time during which the plurality of switches are all turned off at the same time.
